(19) United States
(12) Patent Application Publication
(10) Pub. No.: US 2010/0179238 A1
(43) Pub. Date: Jul. 15, 2010

(54) LOW FORMALDEHYDE FOAM COMPOSITE

(75) Inventors: Volker Hammes, Neustadt (DE); Christof Möck, Mannheim (DE); Bernhard Vath, Mannheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/376,808

(22) PCT Filed: Aug. 1, 2007
(86) PCT No.: PCT/EP07/57927

§ 371 Date: Feb. 9, 2009

(30) Foreign Application Priority Data
Aug. 10, 2006 (EP) 06118715.9

(51) Int. Cl. C08J 9/00

(52) U.S. Cl. 521/155

(57) ABSTRACT

A foam composite which comprises at least one layer of an open-celled amino resin foam MF and a polyurethane foam PU and in which at least one of the layers comprises a formaldehyde scavenger, in particular a foam composite comprising a core comprising an open-celled melamine-formaldehyde resin foam and sheathing comprising a polyurethane foam PU comprising the formaldehyde scavenger on all sides.

The invention relates to a foam composite which comprises at least one layer of an open-celled amino resin foam MF and a polyurethane foam PU and in which at least one of layers comprises a formaldehyde scavenger.

EP-A 1 428 847 describes a process for lowering emissions from polyurethane foams by addition of polymers bearing amino groups, e.g. polyvinylamine.

WO 02/126872 describes the treatment of an open-celled, elastic melamine-formaldehyde resin foam with a polymer comprising primary and/or secondary amino groups in order to lower the formaldehyde emission and its use for hygiene articles.

Seat or rest upholstery comprising a polyurethane foam and having stiffening comprising an open-celled melamine foam are described in EP-A 0 121 049.

It was an object of the present invention to discover a foam composite having reduced formaldehyde emission.

Accordingly, we have found the foam composite described above.

The foam composite preferably comprises a core comprising an open-celled amino resin foam MF, in particular an open-celled melamine-formaldehyde resin foam, and sheathing comprising a polyurethane foam PU on all sides. The sheathing comprising polyurethane foam PU preferably comprises the formaldehyde scavenger.

To reinforce the effect, both the layers comprising the open-celled amino resin foam MF and the layers comprising the polyurethane foam PU can comprise the formaldehyde scavenger.

As open-celled foams, preference is given to using elastic foams based on a melamine/formaldehyde condensation product having a specific density of from 5 to 100 g/l, in particular from 8 to 20 g/l. The cell count is usually in the range from 50 to 300 cells/25 mm. The tensile strength is preferably in the range from 100 to 150 kPa and the elongation at break is in the range from 8 to 20%.

To produce them, it is possible, as described in EP-A 071 672 or EP-A 037 470, to foam and cure a highly concentrated, blowing agent-comprising solution or dispersion of a melamine-formaldehyde precondensate by means of hot air, stream or microwave radiation. Such foams are commercially available under the trade name Basotect® from BASF Aktiengesellschaft.

The molar ratio of melamine-formaldehyde is generally in the range from 1:1 to 1:5. To produce particularly low-formaldehyde foams, the molar ratio is selected in the range from 1:1.3 to 1:1.8 and a precondensate free of sulfite groups is used, as described in WO 01/94436.

To improve the use properties, the foams can subsequently be heat treated and pressed. The foams can be cut to the desired shape and thickness and have covering layers laminated onto them on one or both sides. For example, a polymer film or metal foil can be applied as covering layer.

The thickness of the layer of open-celled melamine-formaldehyde resin foam MF depends on the intended use. In general, the open-celled foam is used, e.g. for seat cushions, in a thickness in the range from 5 to 500 mm, preferably in the range from 10 to 100 mm.

The polyurethane foams PU are generally obtainable by reacting polyisocyanates with compounds having hydrogen atoms which are reactive toward isocyanates, if appropriate in the presence of catalysts, blowing agents and/or additives.

The polyurethane foam can be applied as a layer to one or more surfaces of the amino resin foam, for example by adhesive bonding. However, the polyurethane foam components are preferably foamed in situ around the amino resin foam as core and sheathing on all sides is obtained as a result.

The thickness of the layers or sheathing of polyurethane foam PU depends on the intended use. In general, the open-celled foam is used, e.g. for seat cushions, in a thickness in the range from 5 to 500 mm, preferably in the range from 10 to 100 mm.

As formaldehyde scavenger, it is possible to use a polymer having amino groups and having a molecular weight of at least 500 g/mol and an amino functionality of at least 3. The formaldehyde scavenger can be added, preferably in small amounts, before, during or after production of the polyurethane or amino resin foam. The formaldehyde scavenger can be used either in the layer of the open-celled amino resin foam MF or in the layer of polyurethane foam PU or in both layers.

Particular preference is given to polymers having amino groups and having a molecular weight of at least 500 and an amino functionality of at least 3, with the ratio of molecular weight to amino functionality being from 40 to 500, in an amount of from 10⁻⁴ to <0.1% by weight, based on the total weight of the polyurethane or amino resin foam. In preferred embodiments, it was possible to reduce the formaldehyde emissions of foam composites to below the detection limit of the measurement method employed.

For the purposes of the present invention, polymers having amino groups are all polymeric substances which have primary and/or secondary amino groups. Preference is given to the primary or secondary amino groups being present as side group in the polymer.

In a preferred embodiment, the polymers having amino groups have a number average molecular weight of at least 500 g/mol, preferably at least 1000 g/mol, more preferably at least 1500 g/mol, particularly preferably at least 2000 g/mol, in particular at least 2500 g/mol. There is generally no upper limit to the number-average molecular weight, but it should preferably be not more than 1 000 000 g/mol, particularly preferably not more than 750 000 g/mol.

The polymers having amino groups generally have an amino functionality per polymer molecule of at least 3, preferably at least 5, more preferably at least 10, particularly preferably at least 20 and very particularly preferably at least 50. There is generally no upper limit to the amino functionality, but it should preferably be not more than 20 000, particularly preferably not more than 15 000, in particular not more than 10 000.

In a preferred embodiment, the polymers having amino groups have a ratio of molecular weight to amino functionality of from 40 to 500, more preferably from 50 to 300, particularly preferably from 60 to 250, in particular from 70 to 200.

The polymers having amino groups are preferably selected from among polymers comprising vinylamine units, crosslinked polyamidoamines, crosslinked polyamidoamines grafted with ethylenimine, polyethylenimines, alkoxylated polyethylenimines, crosslinked polyethylenimines, amidated polyethylenimines, alkylated polyethylenimines, polyamines, amine-epichlorohydrin polycondensates, water-soluble polyaddition products of multifunctional epoxides and multifunctional amines, alkoxylated polyamines, polyallylamines and condensates of lysine, ornithine or arginine or mixtures thereof.

To prepare polymers comprising vinylamine units, it is possible to start from, for example, open-chain N-vinylcarboxamides of the formula

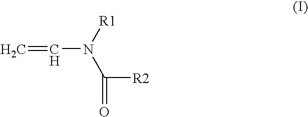

where R¹ and R² can be identical or different and are each hydrogen or C₁-C₆-alkyl. Suitable monomers are, for example, N-vinylformamide (R¹═R²=H in the formula I), N-vinyl-N-methylformamide, N-vinylacetamide, N-vinyl-N-methylacetamide, N-vinyl-N-ethylacetamide, N-vinyl-N-methylpropionamide and N-vinylpropionamide. To prepare the polymers, the monomers mentioned can be polymerized either alone, in admixture with one another or together with other monoethylenically unsaturated monomers. Homopolymers or copolymers of N-vinylformamide are preferably used as starting materials. Polymers comprising vinylamine units are known, for example, from U.S. Pat. No. 4,421,602, U.S. Pat. No. 5,334,287, EPA-0 216 387 and EPA-0 251 182. They are obtained by hydrolysis of polymers comprising monomers of the formula I in polymerized form by means of acids, bases or enzymes.

Monoethylenically unsaturated monomers which can be copolymerized with the N-vinylcarboxamides are all compounds which are copolymerizable therewith. Examples are vinyl esters of saturated carboxylic acids having from 1 to 6 carbon atoms, e.g. vinyl formate, vinyl acetate, vinyl propionate and vinyl butyrate, and vinyl ethers such as C₁-C₆-alkyl vinyl ethers, e.g. methyl or ethyl vinyl ether. Further suitable comonomers are ethylenically unsaturated C₃-C₆-carboxylic acids, for example acrylic acid, methacrylic acid, maleic acid, crotonic acid, itaconic acid and vinylacetic acid and also their alkali metal and alkaline earth metal salts, esters, amides and nitriles of the carboxylic acids mentioned, for example methyl acrylate, methyl methacrylate, ethyl acrylate and ethyl methacrylate.

Further suitable carboxylic esters are derived from glycols or polyalkylene glycols, with only one OH group being esterified in each case, e.g. hydroxyethyl acrylate, hydroxyethyl methacrylate, hydroxypropyl acrylate, hydroxybutyl acrylate, hydroxypropyl methacrylate, hydroxybutyl methacrylate, and also acrylic monoesters of polyalkylene glycols having a molar mass of from 500 to 10 000. Further suitable comonomers are esters of ethylenically unsaturated carboxylic acids with amino alcohols, for example dimethylaminoethyl acrylate, dimethylaminoethyl methacrylate, diethylaminoethyl acrylate, diethylaminoethyl methacrylate, dimethylaminopropyl acrylate, dimethylaminopropyl methacrylate, diethylaminopropyl acrylate, dimethylaminobutyl acrylate and diethylaminobutyl acrylate. The basic acrylates can be used in the form of the free bases, the salts with mineral acids such as hydrochloric acid, sulfuric acid or nitric acid, the salts with organic acids such as formic acid, acetic acid, propionic acid or sulfonic acids or in quaternized form. Suitable quaternizing agents are, for example, dimethyl sulfate, diethyl sulfate, methyl chloride, ethyl chloride or benzyl chloride.

Further suitable comonomers are amides of ethylenically unsaturated carboxylic acids, e.g. acrylamide, methacrylamide, and N-alkylmonoamides and diamides of monoethylenically unsaturated carboxylic acids having alkyl radicals of from 1 to 6 carbon atoms, e.g. N-methylacrylamide, N,N-dimethylacrylamide, N-methylmethacrylamide, N-ethylacrylamide, N-propylacrylamide and tert butylacrylamide, and also basic (meth)acrylamides such as dimethylaminoethylacrylamide, dimethylaminoethylmethacrylamide, diethylaminoethylacrylamide, diethylaminoethylmethacrylamide, dimethylaminopropylacrylamide, diethylaminopropylacrylamide, dimethylaminopropylmethacrylamide and diethylaminopropylmethacrylamide.

Further suitable comonomers are N-vinylpyrrolidone, N-vinylcaprolactam, acrylonitrile, methacrylonitrile, N-vinylimidazole and substituted N-vinylimidazoles such as N-vinyl-2-methylimidazole, N-vinyl-4-methylimidazole, N-vinyl-5-methylimidazole, N-vinyl-2-ethylimidazole and N-vinylimidazolines such as N-vinylimidazoline, N-vinyl-2-methylimidazoline and N-vinyl-2-ethylimidazoline. N-Vinylimidazoles and N-vinylimidazolines can be used in the form of the free bases or else neutralized with mineral acids or organic acids or in quaternized form, with quaternization preferably being carried out using dimethyl sulfate, diethyl sulfate, methyl chloride or benzyl chloride. Diallyldialkylammonium halides such as diallyldimethylammonium chlorides are also possible.

Further comonomers which can be used are alkenes such as ethene, propene, butene, isobutene, hexene and butadiene.

Further possible comonomers are monomers comprising sulfo groups, for example vinylsulfonic acid, allylsulfonic acid, methallylsulfonic acid, styrenesulfonic acid, the alkali metal or ammonium salts of these acids or 3-sulfopropyl acrylate, with the content of cationic units in the amphoteric copolymers exceeding the content of anionic units, so that the polymers have an overall cationic charge.

The copolymers comprise, for example,
from 99.99 to 1 mol %, preferably from 99.9 to 5 mol %, of N-vinylcarboxamides of the formula I and
from 0.01 to 99 mol %, preferably from 0.1 to 95 mol %, of other monoethylenically unsaturated monomers which are copolymerizable therewith
   in copolymerized form.

To prepare polymers comprising vinylamine units, homopolymers of N-vinylformamide or copolymers obtainable by copolymerization of
N-vinylformamide with
vinyl formate, vinyl acetate, vinyl propionate, acrylonitrile, N-vinylcaprolactam, N-vinylurea, acrylic acid, N-vinylpyrrolidone or C₁-C₆-alkyl vinyl ethers
   are preferably used as starting materials and the homopolymers or copolymers are subsequently hydrolyzed to form vinylamine units from the polymerized N-vinylformamide units, with the degree of hydrolysis being, for example, from 0.1 to 100 mol %.

The hydrolysis of the above-described polymers is carried out according to known methods by action of acids, bases or enzymes. Here, the polymerized monomers of the above formula I are converted by elimination of the group

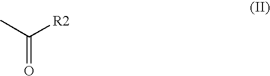

where R² is as defined in formula I, into polymers comprising vinylamine units of the formula

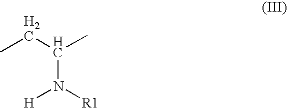

where R¹ is as defined in formula I. When acids are used as hydrolysis agents, the units III are present as ammonium salt.

The homopolymers of the N-vinylcarboxamides of the formula I and their copolymers can be hydrolyzed to a degree of from 0.1 to 100 mol %, preferably from 70 to 100 mol %. In most cases, the degree of hydrolysis of the homopolymers and copolymers is from 5 to 95 mol %. The degree of hydrolysis of the homopolymers is the same as the content of vinylamine units in the polymers. In the case of copolymers comprising vinyl esters in copolymerized form, hydrolysis of the ester groups to form vinyl alcohol units can occur in addition to the hydrolysis of the N-vinylformamide units. This is the case particularly when the hydrolysis of the copolymers is carried out in the presence of sodium hydroxide. Copolymerized acrylonitrile is likewise altered chemically in the hydrolysis. It forms, for example, amide groups or carboxyl groups. The homopolymers and copolymers comprising vinylamine units may comprise up to 20 mol % of amidine units which are formed, for example, by reaction of formic acid with two adjacent amino groups or by intramolecular reaction of an amino group with an adjacent amide group of, for example, polymerized N-vinylformamide. The molar masses of the polymers comprising vinylamine units are, for example, from 500 to 10 million, preferably from 1000 to 5 million (determined by light scattering). This molar mass range corresponds, for example, to K values of from 5 to 300, preferably from 10 to 250 (determined by the H. Fikentscher method in 5% strength aqueous sodium chloride solution at 25° C. and a polymer concentration of 0.5% by weight).

The polymers comprising vinylamine units are preferably used in salt-free form. Salt-free aqueous solutions of polymers comprising vinylamine units can, for example, be prepared from the above-described salt-comprising polymer solutions by means of ultrafiltration over suitable membranes at cutoffs of, for example, from 1000 to 500 000 dalton, preferably from 10 000 to 300 000 dalton. The aqueous solutions of other polymers comprising amino and/or ammonium groups which are described below can also be obtained in salt-free form by means of ultrafiltration.

Polyethylenimines are prepared, for example, by polymerization of ethylenimine in aqueous solution in the presence of acid-releasing compounds, acids or Lewis acids as catalyst. Polyethylenimines have, for example, molar masses of up to 2 million, preferably from 200 to 1 000 000. Particular preference is given to using polyethylenimines having molar masses of from 500 to 750 000. Water-soluble crosslinked polyethylenimines which are obtainable by reaction of polyethylenimines with crosslinkers such as epichlorohydrin or bischlorohydrin ethers of polyalkylene glycols having from 2 to 100 ethylene oxide and/or propylene oxide units and still have free primary and/or secondary amino groups are also suitable. Amidic polyethylenimines which are obtainable, for example, by amidation of polyethylenimines with C₁-C₂₂-monocarboxylic acids are suitable, too. Further suitable cationic polymers are alkylated polyethylenimines and alkoxylated polyethylenimines. The alkoxylation is effected using, for example, from 1 to 5 ethylene oxide or propylene oxide units per NH unit in the polyethylenimine.

Suitable polymers comprising primary and/or secondary amino and/or ammonium groups also include polyamidoamines which are obtainable, for example, by condensation of dicarboxylic acids with polyamines. Suitable polyamidoamines are obtained, for

example, by reacting dicarboxylic acids having from 4 to 10 carbon atoms with polyalkylenepolyamines which comprise from 3 to 10 basic nitrogen atoms in the molecule. Suitable dicarboxylic acids are, for example, succinic acid, maleic acid, adipic acid, glutaric acid, suberic acid, sebacic acid or terephthalic acid. In the preparation of the polyamidoamines, it is also possible to use mixtures of dicarboxylic acids and likewise mixtures of a plurality of polyalkylenepolyamines. Suitable polyalkylenepolyamines are, for example, diethylenetriamine, triethylenetetramine, tetraethylenepentamine, dipropylenetriamine, tripropylenetetramine, dihexamethylenetriamine, aminopropylethylenediamine and bisaminopropylethylenediamine. To prepare the polyamidoamines, the dicarboxylic acids and polyalkylenepolyamines are heated to elevated temperatures, e.g. temperatures in the range from 120 to 220° C., preferably from 130 to 180° C. The water formed in the condensation is removed from the system. Lactones or lactams of carboxylic acids having from 4 to 8 carbon atoms can, if appropriate, also be used in the condensation. Use is made of, for example, from 0.8 to 1.4 mol of a polyalkylenepolyamine per mole of a dicarboxylic acid.

Further polymers comprising amino groups are polyamidoamines grafted with ethylenimine. They can be obtained from the above-described polyamidoamines by reaction with ethylenimine in the presence of acids or Lewis acids, e.g. sulfuric acid or boron trifluoride etherates, at temperatures of, for example, from 80 to 100° C. Compounds of this type are described, for example, in DE-B-24 34 816.

Optionally crosslinked polyamidoamines which are, if appropriate, additionally grafted with ethylenimine prior to crosslinking are also possible as cationic polymers. The crosslinked, ethylenimine-grafted polyamidoamines are water-soluble and have, for example, a mean molecular weight of from 3000 to 2 million dalton. Customary crosslinkers are, for example, epichlorohydrin or bischlorohydrin ethers of alkylene glycols and polyalkylene glycols.

Possible polymers having primary and/or secondary amino and/or ammonium groups also include polyallylamines. Polymers of this type are obtained by homopolymerization of allylamine, preferably in acid-neutralized form, or by copolymerization of allylamine with other monoethylenically unsaturated monomers which are described above as comonomers for N-vinylcarboxamides.

In a particularly preferred embodiment, polyvinylamine is used as polymer having amino groups. The polyvinylamine used preferably has a number average molecular weight of from 500 to 1 000 000 g/mol and a ratio of number average molecular weight to amino functionality of from 40 to 500.

In general, the polymers having amino groups are added to the polyurethane or amino resin foam in an amount which is sufficient to reduce the formaldehyde emission to the desired extent. In general, a small amount of polymer having amino groups is necessary.

In a preferred embodiment, the polymer having amino groups is added in an amount of from 10⁻⁴ to 5% by weight, preferably from 10⁻⁴ to 1% by weight, more preferably from 0.001 to <0.1% by weight, in particular from 0.005 to 0.05% by weight, based on the total weight of the polyurethane or amino resin foam, to the polyurethane or amino resin foam.

The addition of the polymers having amino groups to the polyurethane or amino resin foam can be carried out by means of various procedures.

One way is to add the polymer having amino groups before and/or during the production of the polyurethane or amino resin foam.

For this purpose, the polymer having amino groups is added either to the isocyanate component or the polyol component, preferably the polyol component, and this mixture is subsequently reacted with the other component to produce a polyurethane foam. The addition can be carried out either before mixing of polyol component and isocyanate component or else directly during the mixing of the components themselves. The polymer having amino groups is preferably added in the above-described amounts. The polymer having amino groups can be added in pure form or it is taken up in a solvent beforehand and then added to the isocyanate component or the polyol component. A preferred solvent for the polymer having amino groups is water.

Another possibility is to add the polymer having amino groups to the finished polyurethane or amino resin foam. This addition is usually carried out by application of a solution or dispersion comprising the polymer. The application can, for example, be effected by dipping a polyurethane or amino resin foam into a liquid which comprises a polymer comprising primary and/or secondary amino groups in dissolved or dispersed form. As an alternative, the liquid comprising the dissolved or dispersed polymeric treatment agent can also be applied by spraying onto the foam surface. The solvent is then removed from the foam body which has been treated in this way, e.g. by drying the foam.

In the case of the amino resin foams, the addition of the polymer having amino groups is preferably carried out after production of the foam, if appropriate during heat treatment. For example, hot heat treatment air to which the polymer having amino groups has been added, e.g. in the form of an aerosol, can be passed through the amino resin foam to remove all volatile constituents. In this way, the formaldehyde emission of the foams can be reduced and, if appropriate, the foams can be made hydrophilic without the foams having to be subsequently subjected to a further treatment.

The foam composite of the invention can be used for various applications in which low formaldehyde emissions are desired. The foam composite of the invention is preferably used for seat upholstery, for example in rail vehicles or aircraft.

1. A foam composite comprising at least one layer of an open-celled amino resin foam MF and a polyurethane foam PU, wherein at least one of the layers comprises a formaldehyde scavenger.

2. The foam composite according to claim 1 which comprises a core comprising an open-celled amino resin foam MF and sheathing comprising a polyurethane foam PU on all sides.

3. The foam composite according to claim 1 which comprises an open-celled melamine-formaldehyde resin foam as open-celled amino resin foam.

4. The foam composite according to claim 1, wherein both the layers comprising the open-celled amino resin foam MF and the layers comprising the polyurethane foam PU comprise the formaldehyde scavenger.

5. The foam composite according to claim 2, wherein the sheathing comprising polyurethane foam PU comprises the formaldehyde scavenger.

6. The foam composite according to claim 1 which comprises a polymer having amino groups and having a molecular weight of at least 500 g/mol and an amino functionality of at least 3 as formaldehyde scavenger.

7. The foam composite according to claim 6 which comprises a polyvinylamine as formaldehyde scavenger.

8. A seat upholstery comprising a foam composite according to claim 1.

9. The foam composite according to claim 2 which comprises an open-celled melamine-formaldehyde resin foam as open-celled amino resin foam.

10. The foam composite according to claim 2, wherein both the layers comprising the open-celled amino resin foam MF and the layers comprising the polyurethane foam PU comprise the formaldehyde scavenger.

11. The foam composite according to claim 3, wherein both the layers comprising the open-celled amino resin foam MF and the layers comprising the polyurethane foam PU comprise the formaldehyde scavenger.

12. The foam composite according to claim 3, wherein the sheathing comprising polyurethane foam PU comprises the formaldehyde scavenger.

13. The foam composite according to claim 2 which comprises a polymer having amino groups and having a molecular weight of at least 500 g/mol and an amino functionality of at least 3 as formaldehyde scavenger.

14. The foam composite according to claim 3 which comprises a polymer having amino groups and having a molecular weight of at least 500 g/mol and an amino functionality of at least 3 as formaldehyde scavenger.

15. The foam composite according to claim 4 which comprises a polymer having amino groups and having a molecular weight of at least 500 g/mol and an amino functionality of at least 3 as formaldehyde scavenger.

16. The foam composite according to claim 5 which comprises a polymer having amino groups and having a molecular weight of at least 500 g/mol and an amino functionality of at least 3 as formaldehyde scavenger.

17. A seat upholstery comprising a foam composite according to claim 2.

18. A seat upholstery comprising a foam composite according to claim 3.

19. A seat upholstery comprising a foam composite according to claim 4.

20. A seat upholstery comprising a foam composite according to claim 5.
